(19) United States
(12) Patent Application Publication
(10) Pub. No.: US 2003/0037000 A1
(43) Pub. Date: Feb. 20, 2003

(54) System and method for creating a multi-use card having banking and telephone calling accounts

(76) Inventor: Douglas M. Fieldhouse, Lake Oswego, OR (US)

Correspondence Address: KOLISCH HARTWELL, P.C., 520 S.W. YAMHILL STREET, SUITE 200, PORTLAND, OR, 97204, US

(21) Appl. No.: 10/219,455

(22) Filed: Aug. 14, 2002

Related U.S. Application Data
(60) Provisional application No. 60/312,451, filed on Aug. 14, 2001.

(51) Int. Cl. G06F 17/60

(52) U.S. Cl. 705/43

(57) ABSTRACT

A system and method for creating a multi-use card having an associated bank account and telephone calling account. The method typically includes reading a user's bank card at an automated teller machine. Typically, the bank card is associated with a preexisting bank account. The method further includes prompting the user, at the automated teller machine, to convert the bank card into a multi-use banking/telephone calling card that is associated both with the preexisting bank account and with a to-be-created telephone calling account. The method further includes, in response to a request by the user, creating a telephone calling account linked to the bank card, such that the bank card is converted into a multi-use banking/telephone calling card that is associated both with the preexisting bank account and with the newly created telephone calling account.

### CROSS REFERENCE TO RELATED APPLICATION

This application claims priority under 35 U.S.C. § 119 to U.S. Provisional Patent Application Serial No. 60/312,451 of Douglas M. Fieldhouse, entitled “SYSTEM AND METHOD FOR CREATING A MULTI-USE CARD HAVING BANKING AND TELEPHONE CALLING ACCOUNTS,” which was filed on Aug. 14, 2001, the entire disclosure of which is hereby incorporated by reference for all purposes.

### TECHNICAL FIELD

The present invention relates generally to telephony and banking, and more particularly to creating multi-use card having banking and telephone calling card accounts.

### BACKGROUND

Millions of consumers each year make telephone calls using stored-value telephone calling accounts. Stored-value telephone calling accounts typically require a user to carry an additional card, and/or memorize an additional account number to go along with other cards in the user's possession, such as credit, debit, mileage, and dining cards. Therefore, it would be desirable to provide a system and method for creating a multi-use card having banking and telephone calling card accounts for consumers that would improve their quality of life by limiting the proliferation of numbers and cards required for daily activities.

### SUMMARY OF THE INVENTION

A system and method are provided for creating a multi-use card having an associated bank account and telephone calling account. The method typically includes reading a user's bank card at an automated teller machine. Typically, the bank card is associated with a preexisting bank account. The method further includes prompting the user, at the automated teller machine, to convert the bank card into a multi-use banking/telephone calling card that is associated both with the preexisting bank account and with a to-be-created telephone calling account. The method further includes, in response to a request by the user, creating a telephone calling account linked to the bank card, such that the bank card is converted into a multi-use banking/telephone calling card that is associated both with the preexisting bank account and with the newly created telephone calling account.

### BRIEF DESCRIPTION OF THE DRAWINGS

FIG. 1 is a schematic view of a system according to one embodiment of the present invention.

FIG. 2 is a front view of a bankcard according to one embodiment of the present invention.

FIG. 3 is a rear view of the backside of the bankcard shown in FIG. 2.

FIG. 4 is a flowchart of a method for creating a telephone calling account according one embodiment of the present invention.

FIG. 5 is a continuation of the flowchart in FIG. 4, which further shows transferring funds from a bank account to a telephone calling account.

### DETAILED DESCRIPTION OF THE PREFERRED EMBODIMENTS

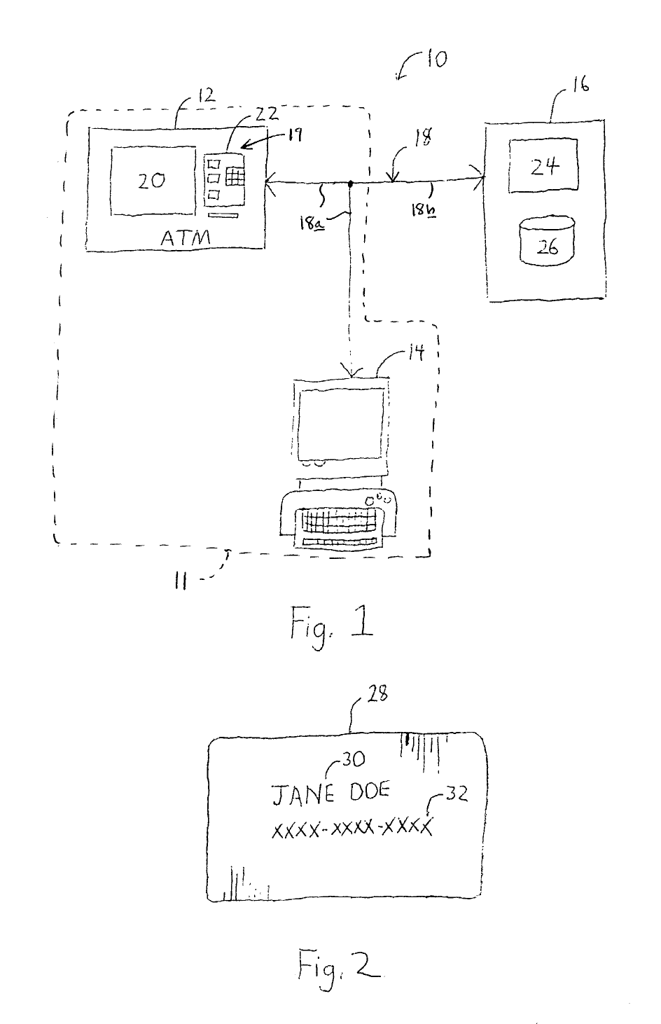

Referring initially to FIG. 1, one embodiment of a card conversion system according to the present invention in generally shown at 10. System 10 includes a bank computer system 11 having an Automated Teller Machine (ATM) 12 and a bank computer 14 linked by a first network 18a. System 10 further includes a telecommunications gateway server 16 linked to the ATM and bank computer via a second network 18b. Network 18a and 18b are interconnected and may be collectively referred to simply as network 18. System 10 is configured so that a user can easily convert a preexisting bankcard into a multi-use banking/telephone calling card by creating a linked telephone calling account having the same number as the account number of the bankcard. This obviates the need for a user to obtain a separate card for the telephone calling account.

ATM 12 includes a user interface 19 having a display screen 20 and a user input device 22. Display screen 20 is typically a cathode ray tube (CRT) or flat panel display. User input device 22 is an interactive device that typically includes a keyboard used for manipulating ATM 12, and a slot for inserting a bankcard.

Bank computer 14 typically includes a processing unit configured to carry out account transactions requested from ATM 12 regarding a user's bank account and/or telephone calling account. One specific transaction bank computer 14 is configured to carry out includes transferring funds from the user's bank account to the user's telephone calling account.

Gateway server 16 includes a telephone calling account generation module 24 and a database 26. Telephone calling account generation module 24 is configured to create telephone calling accounts upon request from gateway server 16. Database 26 is typically configured to store telephone-calling accounts created by telephone calling account generation module 24.

One suitable gateway server that may be used in accordance with the present invention is shown and described in co-pending U.S. patent application Ser. No. 09/436,977, filed Nov. 9, 1999, entitled a “Telephone Calling Account System And Method”, the entire disclosure of which is herein incorporated by reference. Transactions taking place over gateway server 16 may be screened for fraud according to the methods described in co-pending U.S. patent application Ser. No. 09/479,768, filed Jan. 7, 2000, entitled a “Fraud Prevention System And Method”, the entire disclosure of which is herein incorporated by reference.

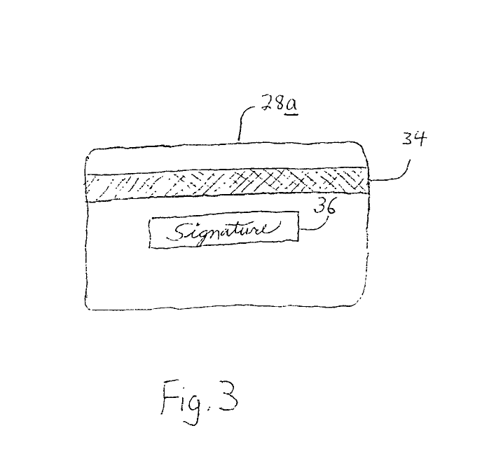

Referring next to FIG. 2, a bankcard 28 includes a name 30 of an owner of a bankcard and a bank account number 32. Bankcard 28 is typically a debit card that can be used to purchase goods or, at locations such as ATM 12, can be used to receive account status, transfer, deposit, and/or withdraw funds from the user's bank account. Alternatively, the bankcard may be a credit card or other card used for purchasing goods and services. The bank account and bank account number of bankcard 28 are typically created before the creation of a telephone calling account according to one preferred embodiment of the present invention.

FIG. 3 shows a backside 28a of bankcard 28 that includes a magnetic strip 34 and a signature block 36. Alternatively, the backside 28a of a bankcard may include such elements as shown and described in co-pending U.S. patent application Ser. No. 09/436,977.

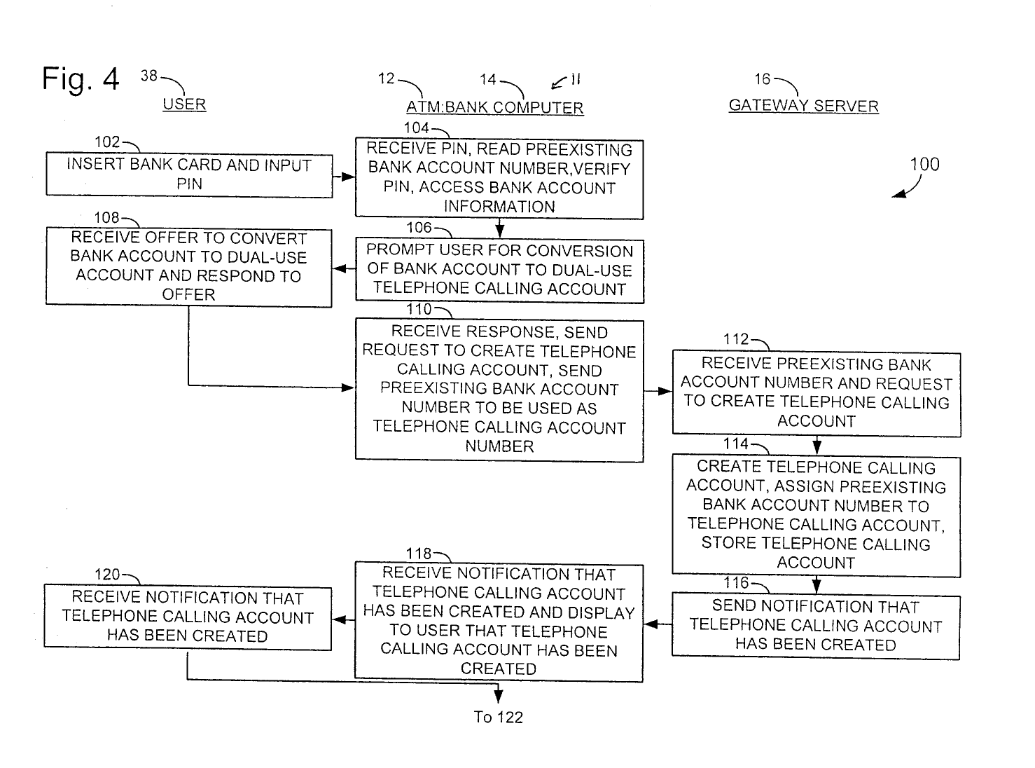

Referring next to FIG. 4, a method for creating a multi-use telephone calling account and card according to one embodiment of the present invention is generally shown at 100. It will be appreciated that steps 102, 108, 120, 124, and 138 are typically performed by user 38. Steps 104, 106, 110, 118, 122, 126, 128, 130, and 136 are typically performed by banking system 11, that is, by ATM 12 and bank computer 14 acting in concert with each other via network 18. Steps 112, 114, 116, 132, and 134 are typically performed by gateway server 16.

At 102, the method typically includes user 38 inserting a bankcard and inputting a bank account PIN (person identification number) at ATM 12. Typically, a user will input a four-digit PIN to access a bank account at an ATM. The PIN is not printed on the user's bankcard and is kept confidential by the user.

At 104, the method typically includes ATM 12 reading a preexisting bank account number encoded on a magnetic strip of the inserted bankcard, receiving the PIN, verifying that the PIN is associated with the corresponding bank account, and accessing user 38's bank account.

At 106, the method typically includes ATM 12 prompting user 38 through display screen 20 to create a multi-use banking/telephone calling card.

At 108, the method typically includes user 38 receiving an offer from ATM 12 to create a multi-use telephone banking/calling card and responding to such an offer.

At 110, the method typically includes ATM 12 receiving a response from user 38. The response is typically a request to create a multi-use banking/telephone calling card. If user 38 requests creation of a multi-use bank/telephone calling card, 110 further includes ATM 12 sending the preexisting bank account number to be used as the telephone calling account and a request to create a telephone calling account to gateway server 16.

At 112, the method typically includes gateway server 16 receiving the preexisting bank account number and request to create a multi-use banking/telephone calling card from ATM 12. Alternatively, the method may include gateway server 16 receiving requests to create a multi-use banking/telephone calling card as shown and described in co-pending U.S. patent application Ser. No. 09/436,977.

At 114, the method typically includes gateway server 16 creating a telephone calling account via telephone calling account generation module 24, assigning to the telephone calling account the preexisting bank account number of the preexisting bank account, and storing the newly created telephone calling account in database 26.

At 116, the method typically includes gateway server 16 sending notification to ATM 12 of creation of the telephone calling account.

At 118, the method typically includes ATM 12 receiving notification from gateway server 16 that a telephone calling account has been created and then displaying to user 38 via display screen 20 that a telephone calling account has been created.

At 120, the method typically includes user 38 receiving notification from ATM 12 that a telephone calling account has been created.

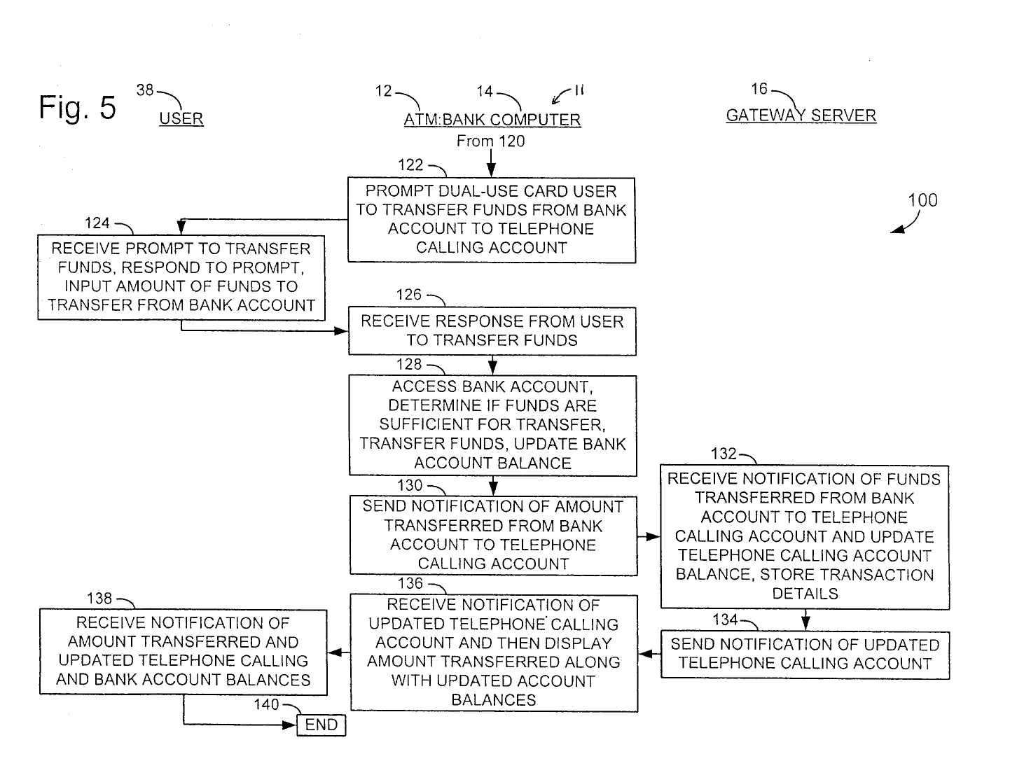

Referring next to FIG. 5, a continuation of the method shown in FIG. 4 is generally shown to include steps for transferring funds to the newly created telephone calling account according to one embodiment of the present invention.

At 122, the method typically includes ATM 12 prompting user 38 to transfer funds from a bank account to the newly created telephone calling account.

At 124, the method typically includes user 38 receiving a prompt via display screen 20 to transfer funds and responding to the prompt. User 38 may choose to transfer funds at this time or not, thus ending the transaction. Typically, to transfer funds at ATM 12, user 38 inputs a specified amount to transfer via input device 22.

At 126, the method typically includes ATM 12 receiving a response from user 38 to transfer the specified amount of funds from the bank account to the newly created telephone calling account. Typically, the newly created account is a prepaid calling account, and the user pays ahead of time for calling units that are credited to the account.

At 128, the method typically includes ATM 12 accessing the bank account balance, determining if the bank account balance is sufficient to transfer the specified funds, transferring funds from the bank account to the newly created telephone calling account, and updating the bank account balance after the funds are transferred to the telephone calling account.

At 130, the method typically includes ATM 12 sending notification of the transaction and funds transferred to the telephone calling account to gateway server 16.

At 132, the method typically includes gateway server 16 receiving notification of the funds transferred from the bank account to the telephone calling account, updating the telephone calling account balance, and storing the account transaction and updated balance in database 26.

At 134, the method typically includes gateway server 16 notifying ATM 12 that user 38's telephone calling account balance has been updated.

At 136, the method typically includes ATM 12 receiving notification of user 38's updated telephone calling account balance from gateway server 16 and displaying the amount transferred from the bank account to the telephone calling account, along with the updated bank and telephone calling account balances to user 38 via display screen 20.

At 138, the method typically includes user 38 receiving notification of the transferred amount and updated bank and telephone calling account balances.

At 140, the method typically includes ending the transaction.

Through the above described method, a user from the convenience of an ATM, may create a telephone calling account linked to the user's bankcard. The telephone calling account typically has the same number as the user's bankcard, and calling units may be charged to the user's bank account and placed on the telephone calling account directly from the ATM.

Although the invention has been disclosed in its preferred forms, the specific embodiments thereof as disclosed and illustrated herein are not to be considered in a limiting sense, because numerous variations are possible. The subject matter of the invention includes all novel and non-obvious combinations and subcombinations of the various elements, features, functions, and/or properties disclosed herein.

I claim:

1. A method for creating a multi-use card having an associated bank account and telephone calling account, the method comprising:
reading a user's bank card at an automated teller machine, the bank card being associated with a preexisting bank account;
prompting the user, at the automated teller machine, to convert the bank card into a multi-use banking/telephone calling card that is associated both with the preexisting bank account and with a to-be-created telephone calling account; and
in response to a request by the user, creating a telephone calling account linked to the bank card, such that the bank card is converted into a multi-use banking/telephone calling card that is associated both with the preexisting bank account and with the newly created telephone calling account.

2. The method of claim 1, wherein the account number of the telephone calling account is designated to be the same as the account number of the bank account.

3. The method of claim 1, further comprising prompting a user to transfer funds from a bank account to the newly created telephone calling account.

4. The method of claim 3, further comprising transferring funds from the bank account to the newly created telephone calling account.

5. The method of claim 1, further comprising sending a request to create the telephone calling account from the automated teller machine to a telecommunications gateway server.

6. The method of claim 5, wherein the step of creating the telephone calling account is performed by the telecommunications gateway server.

7. The method of claim 6, wherein reading the bank card includes reading a preexisting bank account number associated with the bank card.

8. The method of claim 7, further comprising sending the preexisting account number of the bank card to the telecommunications gateway server.

9. The method of claim 8, further comprising, at the telecommunications gateway server, assigning the preexisting bank account number to be the account number of the telephone calling account.

10. A system for use in creating a multi-use card having an associated bank account and telephone calling account, the system comprising:
a bank computer system including an automated teller machine having a user interface configured to read a bank card of a user and identify a preexisting bank account associated with the bank card, the user interface further being configured to prompt the user to create a multi-use banking/telephone calling card that is associated both with the preexisting bank account and with a to-be-created telephone calling account; and
a telecommunications gateway server configured to communicate with the bank computer system via a computer network;
wherein the bank computer system is configured to send a request to the telecommunications server to create a telephone calling account; and
wherein, in response to the request from the bank computer system, the telecommunications gateway server is configured to create a telephone calling account linked to the bank card, such that the bank card is converted into a multi-use banking/telephone calling card that is associated both with the preexisting bank account and with the newly created telephone calling account.

11. The system of claim 10, wherein the automated teller machine is further configured to prompt the user to transfer funds from a bank account to the newly created telephone calling account.

12. The system of claim 11, wherein the bank computer system further is configured to transfer funds from the bank account to the newly created telephone calling account.

13. The system of claim 10, wherein the automated teller machine is further configured to read a preexisting bank account number associated with the bank card.

14. The system of claim 13, wherein the bank computer system is configured to send the preexisting account number of the bank card to the telecommunications gateway server.

15. The system of claim 14, wherein the telecommunications gateway server is configured to assign the preexisting bank account number to be the account number of the telephone calling account.
